(19) United States
(12) Patent Application Publication
(10) Pub. No.: US 2012/0005153 A1
(43) Pub. Date: Jan. 5, 2012

(54) CREATION OF A DATA STORE

(76) Inventors: Mark Joseph Ledwich, Queensland (AU); James Henry Wilson, Queensland (AU)

(21) Appl. No.: 13/148,773

(22) PCT Filed: Feb. 9, 2010
(86) PCT No.: PCT/AU2010/000134

§ 371 Date: Sep. 19, 2011

(30) Foreign Application Priority Data
Feb. 10, 2009 (AU) 2009900509

(51) Int. Cl. G06F 17/30

(52) U.S. Cl. 707/602; 707/803; 707/805; 707/E17.005

(57) ABSTRACT

A method for structuring a data store by analysing source data bases using the steps of relationship discovery, schema merging, hierarchy discovery, heuristic based attribute inclusion and optionally denormalising This is applied to products such as Navision in building an OLAP cube for use in business intelligence applications. Also disclosed is a security adapter to carry security settings from a source data base to an OLAP cube which includes creating a synthetic dimension in the OLAP cube which is a common trait related to all other dimensions in the cube and one role is created for each role in the source data base and users treated as members of those roles as defined in the source data base.

This invention relates to the creation of a datastore for use in B I (Business Intelligence) systems.

### BACKGROUND TO THE INVENTION

Relational databases for CRM and ERP are usually customised to suit the business needs of particular industries. Although some computer companies provide cubes that can be used with these databases they do not take account of the customisations that have taken place. To enable BI systems to carry out their analysis a cumbersome and expert driven process of synchronizing the databases to the analysis cube is needed. The cost of this process is a deterrent to purchasing and implementing BI systems and only large enterprises can justify the costs involved.

In preparing an ERP system for BI the usual steps are to establish the business requirements, source the data requirements, design, build, implement and also manage security.

The first step of this process elicits the business requirements for the system from the users in the organization. This would typically involve a consultant interviewing users around business processes and jointly determining the information those users require to do their job on a day to day basis as well as provide them with information to improve their decision making capabilities. Once business requirements have been gathered, the consultant will identify what data is required and in which system that this data currently resides.

The design phase will be undertaken by the technical consultant and will consist of the following items.

Extraction Transformation and Load (ETL)
The data is extracted from each source system into a staging database. This database is transformed into a star schema structure. Each ETL task must be designed to do this task efficiently. Transformation of the data also need to be designed at this point such as converting methods of converting complex ERP structures into simple reporting structures.

Data Warehouse Design
The warehouse must be designed in such a way as to allow large volumes of data to be accessed rapidly. It must also have a structure that will allow reports to be easily constructed against them.

Cube Design
The cube must be designed so that it can support all of the business requirements. This is typically a complex iterative process involving business analysts and business intelligence specialists. Cubes are constructed of measures and dimensions. Measures represent how an item is measured. For example, a sales representative is measured against revenue and margin. Dimensions break the measures down into business categories. For example, a sales representative is a dimension, the customer is a dimension and the date is a dimension.

Report Design
Reports must be designed to meet the business requirements. Report Parameters, subtotals, headings and format need to be thought through.

Once the design phase is completed, the build phase commences and the following items must be created. As this is technical in nature, a business intelligence developer usually performs this task. For example, with Microsoft's SQL Server, the following tasks would need to be performed by a product specialist:

| Task | Expertise Required |
|---|---|
| Create ETL Jobs | SQL Server Integration Services |
| Build data warehouse | SQL Server Relational Databases |
| | SQL Server Management Studio |
| Build Cubes | SQL Server Analysis Services |
| Report Design | SQL Server Reporting Services |

The implementation phase includes the steps:

Installation
Install the ETL jobs, cubes, data warehouse and reports.

Testing
The whole process must be tested to ensure that the cube and the reports are delivering the correct results to the user. This is normally done by reviewing reports from source systems and then validating them against the BI system.

Training
Ensure that the users can use the cubes and the reports efficiently and that technical support staff have the ability to maintain and customize the system over time.

Traditionally, security requirements for the BI system were gathered as part of the requirements stage. This was built into the cube manually, but a major source of labour was ongoing maintenance and manual synchronization efforts to ensure only the right people saw privileged information.

As illustrated above, building a business intelligence solution for an ERP system is a labour-intensive, specialist-driven process with many complexities.

USA patent application 2005/0149583 discloses a method of merging data in two different versions of the same database by comparing the two databases' metadata and using a difference algorithm to identify the differences and then develop a metadata exchange strategy to merge the two databases.

WO 2007/95959 discloses a method of generating data warehouses and OLAP cubes without requiring knowledge of database query languages. The system uses a star schema. This approach still requires expertise in building the data warehouse for the OLAP cube and this is often too expensive for smaller scale businesses.

WO 2007072501 discloses a system for a business performance platform that has a data source, an instrumentation layer for deriving measurement information from multiple formats and integrating it into a canonical format, a consolidation layer for filtering and pre-processing instrumentation layer output, a business modelling layer and a presentation layer.

USA application 2006/0271568 discloses a method of assembling a data warehouse using data reduction, aggregate and dimension and fulfillment processes.

USA patent application 2005/0033726 discloses a business intelligence system that does a way with a data store and uses meta data view module to access data organised on the basis of data connection, data foundation, Business element and business view and security.

It is an object of this invention to provide an automatic method of preparing a data store for use in creating an OLAP Cube.

A key requirement in delivering a business intelligence solution is the ability to recreate the security settings of the source system in the OLAP cube.

The simplest possible security model restricts what each user can or can't do with a particular entity. Typically permissions determine whether a user can create, read, update or delete, otherwise known as CRUD. Managing the permutations of permission lists for large number of users and entities can be an administrative nightmare.

Copending application 2008905207 discloses a method of carrying over the application level security settings of the source system into the cube by creating a set of permissions for each user in the cube security based on the permissions of their roles in the source system's application-level security model.

USA patent application 2005/0022029 discloses a method of carrying over security settings by creating a data access statement for each user based on their security role. A new file is created for use in the query generator. This does not address the issue of incompatibility between the security treatment in the source databases and in the OLAP cube.

It is an object of this invention to provide a more efficient method of dealing with incompatibility between the security treatment in the source databases and in the OLAP cube.

### BRIEF DESCRIPTION OF THE INVENTION

To this end in a first embodiment this invention provides a method for structuring a data store by analysing the source data bases using the steps of relationship discovery, schema merging, hierarchy discovery, heuristics for attribute inclusion and optionally denormalising.

The present invention presents a method for completely automating the requirements gathering and design stages of this process. Optionally the process can be guided by the user. Of particular note, the invention does not require a traditional data warehouse to build a cube. Also, the invention completely eliminates the need to manually create and maintain a separate security model for data stored in the BI system.

The final output of this invention is a staging database which is used as the source database in the process previously described in copending application 2008905207. Relationships previously articulated in the cube (DSV) are added to the set of relationships. Any existing foreign key relationships in the source databases are also added to the set. In this invention relationships are also discovered from statistical analysis of the source data and using guided relationship discovery with the user. To enable multidimensional analysis data needs to be examinable at different granularities. This invention provides a hook in its workflow that allows for different adapters to be used to naturally discover these hierarchies in different domains.

In another aspect the present invention provides a security adapter to carry security settings from the source data to the OLAP cube by creating a new synthetic dimension in the cube which is a common trait related to all other dimensions in the cube such as an owner or common employer. For example, under the CRM security model, the synthetic dimension introduced is an owner dimension that associates each user with each entity as per the CRM security model. In this way, a particular user is guaranteed to only ever see records they have permission to by filtering out any entities they are not related to.

Security roles in the source data base such as the CRM or ERP system are replicated in the cube, and users are members of those roles as defined in the source data base.

This method has an additional benefit in that it enriches the existing data by combining it with new security information that previously only existed in a metadata layer. For example, this new information can now be leveraged in reports and dashboards by slicing and filtering data by user.

### DEFINITIONS

### CRM

### Customer Relationship Management

### Cube

A multi-dimensional database optimized for fast retrieval and aggregation of data

### DSV

Data Source View—a view of the base system data which maps more naturally to its definition in the cube than the raw data

### Database Schema

The schema of a database system is its structure described in a formal language supported by the database management system (DBMS). In a relational database, the schema defines the tables, the fields in each table, and the relationships between fields and tables.

### ERP

Enterprise Resource Planning is an industry term for the broad set of activities supported by multi-module application software that helps a manufacturer or other business manage the important parts of its business, including product planning, parts purchasing, maintaining inventories

### MDX

The leading query language for multi-dimensional databases is MDX, which was created to query OLAP databases, and has become widely adopted with the realm of OLAP applications.

### Normalization

In the field of relational database design, normalization is a systematic way of ensuring that a database structure is suitable for general-purpose querying and free of certain undesirable characteristics—insertion, update, and deletion anomalies—that could lead to a loss of data integrity. However, this form is not optimal for querying which is why OLAP cubes have a different structure.

### OLAP

OnLine Analytical Processing systems enable users to gain insight into data by providing fast, interactive access to a variety of possible views of information.

The following definitions introduce concepts that reflect the multidimensional view and are basic to OLAP.

A “dimension” is a structure that categorizes data. Commonly used dimensions include customer, product, and time. Typically, a dimension is associated with one or more hierarchies. Several distinct dimensions, combined with measures, enable end users to answer business questions. For example, a Time dimension that categorizes data by month helps to answer the question, “Did we sell more widgets in January or June?”

A “measure” includes data, usually numeric and on a ratio scale, that can be examined and analysed. Typically, one or more dimensions categorize a given measure, and it is described as “dimensioned by” them.

A “hierarchy” is a logical structure that uses ordered levels as a means of organizing dimension members in parent-child relationships. Typically, end users can expand or collapse the hierarchy by drilling down or up on its levels.

A “level” is a position in a hierarchy. For example, a time dimension might have a hierarchy that represents data at the day, month, quarter and year levels.

An “attribute” is a descriptive characteristic of the elements of a dimension that an end user can specify to select data. For example, end users might choose products using a colour attribute. In this instance, the colour attribute is being used as an “axis of aggregation”. Some attributes can represent keys or relationships into other tables. A “query” is a specification for a particular set of data, which is referred to as the query's result set. The specification requires selecting, aggregating, calculating or otherwise manipulating data. If such manipulation is required, it is an intrinsic part of the query.

“Metadata” is a key concept involved in this invention. Metadata is essentially data about data. It is information describing the entities in a database (either relational or multidimensional). It also contains information on the relationship between these entities and the security information detailing what information users are permitted to see.

### Relationship

Data is typically stored in multiple tables in a database. Often the records in one table relate to an entity in another table. Where this is the case, the two tables are considered to be related. In a relational database for example, a special value can be stored with each row that links it to the base entity. For example, imagine a database with a customer table and an address table. The address table has an additional field, Customer ID, which links it with the corresponding customer record in the customer table.

### DETAILED DESCRIPTION OF THE INVENTION

A preferred embodiment of the invention will be described with reference to the drawings in which:

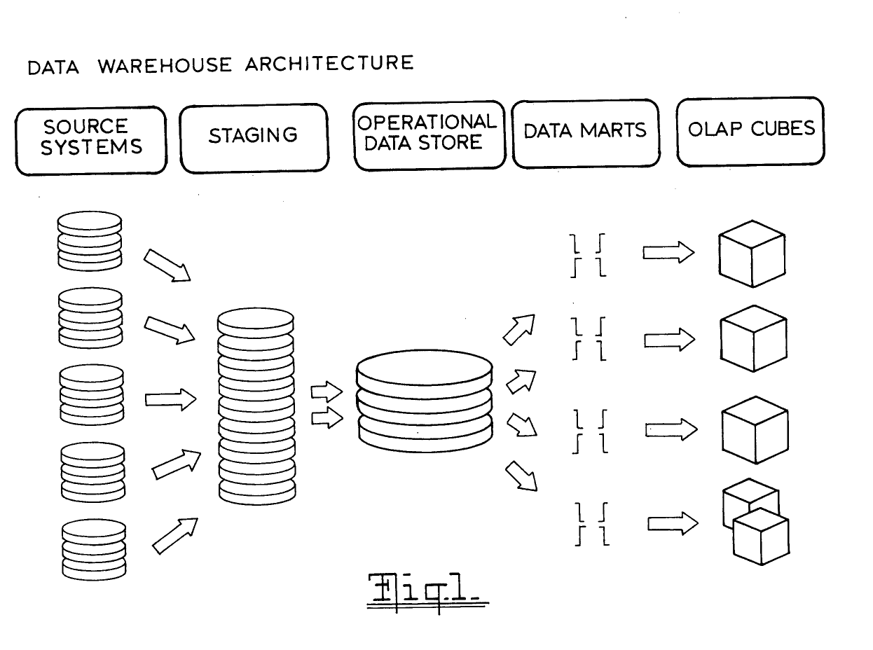

FIG. 1 is a schematic outline of the prior art method;

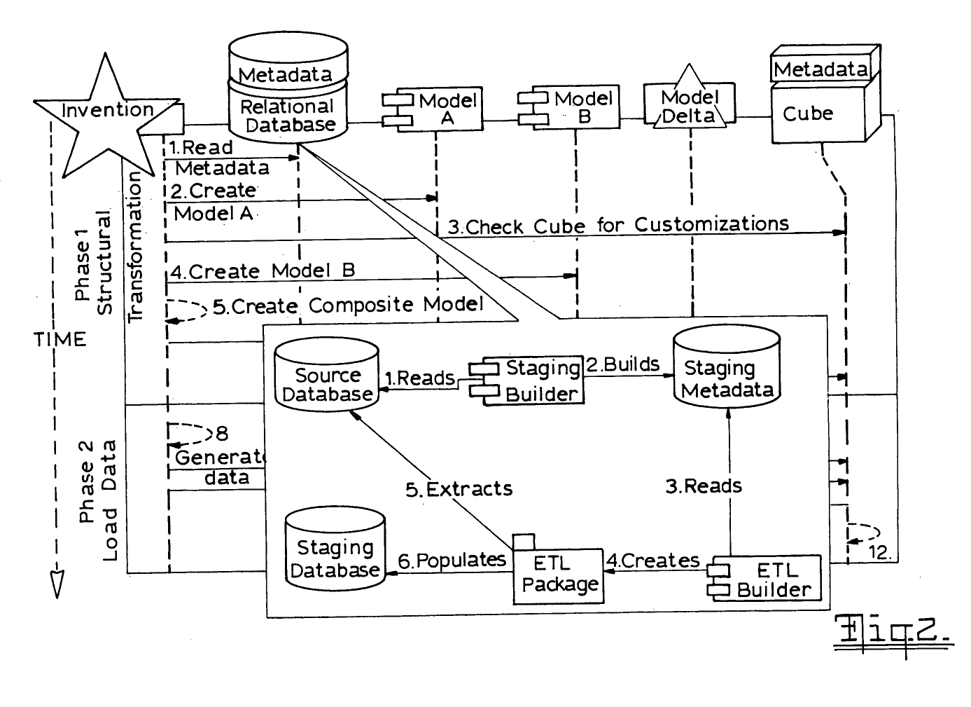

FIG. 2 illustrates where this invention fits in relation to the methodology outlined in co-pending application PCT/AU2009/001326;

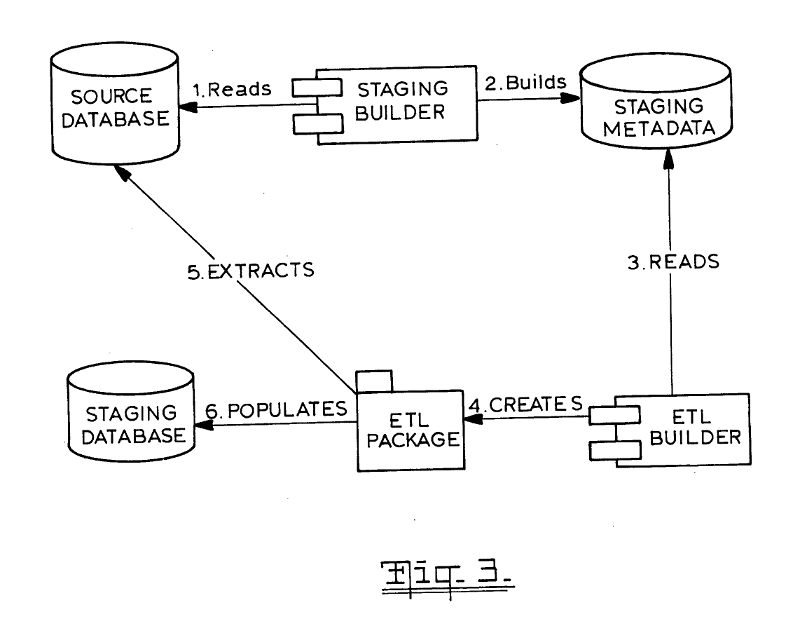

FIG. 3 illustrates schematically the data builder of this invention;

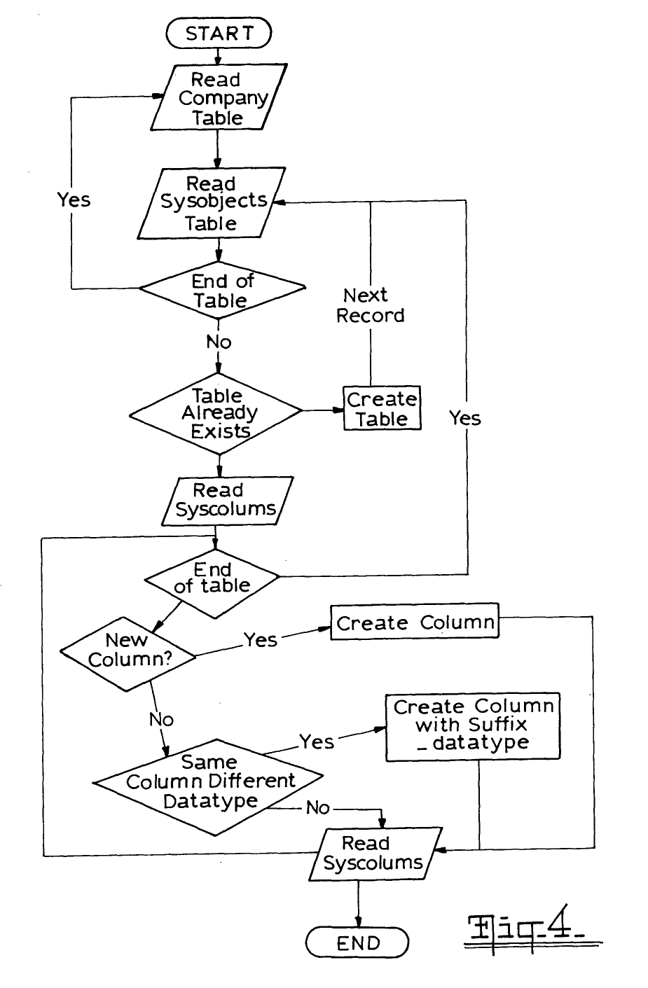

FIG. 4 is a flow chart describing the algorithm for schema merging;

With reference to FIG. 2 in this invention the most important aspect is the functionality of the staging builder.

### Staging Builder

The staging builder incorporates a number of key innovations that prepare a schema for the data store as detailed here.

### Relationship Discovery

An integral part of building a multidimensional database is an understanding of how the different pieces of data relate to each other. These relationships are non-obvious to business users.

The present invention brings several methods to bear at once to form a more complete picture of the relationships that exist in the data. These include:
Foreign keys in the source relational databases
Relationships that already exist in the DSV
Relationships discovered from statistical analysis of the source data
Guided relationship discovery with the user

### Leverage of Existing Known Relationships

Relationships previously articulated in the cube are added to the set of relationships. Any existing foreign key relationships in the source databases are also added to the set.

### Empirical Discovery of Relationships

### Background

An association rule is a simple probabilistic statement about the co-occurrence of certain events in a database, and is particularly applicable to sparse transaction data sets. For the sake of simplicity assume that all variables are binary. An association rule takes the following form:

IF A=1 AND B=1 THEN C=1 with probability p
where A, B, and C are binary variables and p=p(C=1|A=1, B=1), i.e., the conditional probability that C=1 given that A=1 and B=1. The conditional probability p is sometimes referred to as the “accuracy” or “confidence” of the rule, and p(A=1, B=1, C=1) is referred to as the “support”. This pattern or rule structure is deliberately chosen because it is quite simple and interpretable.

Typically the goal is to find all rules that satisfy the constraint that the accuracy p is greater than some threshold.

While the concept of association rules has been around for some time, there are some hurdles to their practical use.

The search problem involved in the discovery of association rules is formidable. Even for binary variables where attention is limited to rules with positive propositions in the left and right hand sides the search space, size is exponential in the order of O(p2^{p}). The present invention adds several innovative heuristics and methods of elimination to mitigate this problem.

### Reducing the Search Space

The search is constrained by only looking for direct 1:1 relationships between columns from different tables. The search set is further reduced by pruning any candidates that have incompatible data types.

### Identifying Matches

Where a potential foreign key relationship has been identified, all distinct values of the candidate key and the column to be matched are found and then a sample of pre-defined size is taken and subjected to association analysis. Where the population is sufficiently small to fit in memory this analysis may be performed in memory for improved performance rather than in the cube.

A further heuristic takes advantage of a common database convention whereby foreign key names start with the name of the table to which they refer, to help identify candidate relationships.

Dealing with Auto-Increment Columns

Frequently primary keys for tables are based on auto-increment columns. Clearly any two tables using this key type could potentially appear related even if they are not. To better discriminate in these circumstances, the invention uses an additional heuristic: the candidate key sample's maximum and minimum values must be within a certain percentage of the maximum and minimum values of those in the foreign table.

### Guided Relationship Discovery

The invention provides a configurable threshold that allows for robust discovery of relationships that are less than perfectly represented in the data, often because they are obscured by data quality issues.

Each rule that is discovered with support above the configured threshold can be incorporated automatically or presented to the user along with live sample data for confirmation. This supervised path is referred to as “guided relationship discovery”.

### Schema Merging

Wherever you have similar data stored in different source tables and wish to form a consolidated view of it, it is necessary to merge the schemas for the tables together in order to form a new table capable of holding the data from all the source tables. Typically the process involves:
Adding a new column to identify the source table of each row of data
Adding all the columns that the source tables have in common (both name and data type)
Adding any columns that are unique to any set of source tables
Where there are two columns with the same name but different data types, each column name is suffixed with its data type and added to the schema

The flow chart shown in FIG. 3 describes the algorithm involved.

### De-Normalization

Most databases are in a relatively normalized form which facilitates smaller database sizes and faster updates but this is suboptimal for querying and analysis. They also lead to relatively complex cubes.

The present invention includes a de-normalization step which simplifies the resulting cube structure and improves performance.

This is achieved by combining two or more tables together, such that each row contains all the information, originally shared across tables, relevant to each record.

### Example

Consider the following tables:

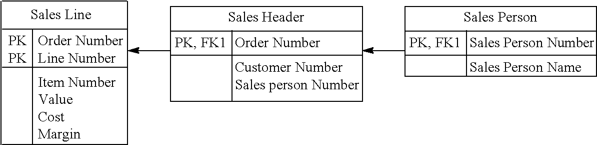

A user wishes to report on sales value, cost of sale and margin, and this is normally done by summarizing the items on the Sales Line table. In this case however, the user also wants to view the same values by Sales Person.

Ordinarily, to do this in the cube it would mean that we have to include the Sales Header table, which is really only needed for its Customer Number and Sales Person Number fields.

### Solution

There are 3 ways of handling this
1. Modify the query in the cube to include all three tables
2. Merge the fields of the three tables into a single table.
3. Add the items as dimensions and measure groups

Option 1 represents the status quo and leads to a complex cube with poor performance. Option 3 leads to an unnecessarily complex cube with referential dimensions.

The best solution is Option 2 and results in the following table which retains all information but allows for faster, simpler queries.

Sales

Order Number
Line Number
Item Number
Value
Cost
Margin
Customer Number
Sales Person Number

### Hierarchy Discovery Adapter

At the core of multidimensional analysis is the capability to examine data at different granularities. These granularities are naturally present in many forms of data. For example, sales data is often examined over time at different granularities—daily, weekly, monthly, quarterly or yearly.

The invention provides a hook in its workflow that allows for different adapters to be used to naturally discover these hierarchies in different domains (application-specific data sources).

In a preferred embodiment, an adapter that automatically uncovers hierarchies in a chart of accounts stored in the Microsoft Dynamics Navision accounting software. In the source database the data might look like this:

| Dimension | Code | Description | Totaling |
|---|---|---|---|
| BRANCH | AWS000 | National Office | |
| BRANCH | AWS001 | National Office | |
| BRANCH | AWS002 | Call Centre | |
| BRANCH | AWS999 | National Office | AWS000 . . . AWS999 |
| | | Total | |
| BRANCH | IA001 | Industrial | |
| BRANCH | ICI002 | Clark Industrial | |
| BRANCH | ICI010PLUM | Plumbing | |
| BRANCH | ICI020D&C | Design & | |
| | | Construction | |
| BRANCH | ICI200 | Tanks | |
| BRANCH | ICI210SA | South Australia | |
| BRANCH | ICI220VIC | Victoria | |
| BRANCH | ICI230QLD | Queensland | |
| BRANCH | ICI240NSW | New South Wales | |
| BRANCH | ICI250WA | Western Australia | |
| BRANCH | ICI299 | Tanks Total | ICI200 . . . ICI299 |
| BRANCH | ICI999 | Total Clark | ICI002 . . . ICI999 |
| | | Industrial | |
| BRANCH | IZ999 | Total Industrial | IA001 . . . IZ999 |

The “Totalling” column specifies ranges of accounts for parent accounts. These ranges are often nested. By creating a Navision specific hierarchy adapter, we are able to automatically discover and create an account hierarchy in the cube that reflects this structure from the flat table. In this case the algorithm might be something like:

for each record rec in the table

for each record child in the table whose account code lies within rec’s

totalling range

add rec to the child record’s list of parents

end for

end for
sort each record’s parent list by their respective parent counts to order the
hierarchy

The level information is then trivially derivable from each record's parent list. The end result might look like this:

| Level1 | Level2 | Level3 | Code |
|---|---|---|---|
| National Office Total | National Office | National Office | AWS000 |
| National Office Total | National Office | National Office | AWS001 |
| National Office Total | Call Centre | Call Centre | AWS999 |
| Total Industrial | Industrial | Industrial | IA001 |
| Total Industrial | Total Clarke | Total Clarke | ICI002 |
| | Industrial | Industrial | |
| Total Industrial | Total Clarke | Total Clarke | ICI010PLUM |
| | Industrial | Industrial | |
| Total Industrial | Total Clarke | Total Clarke | ICI020D&C |
| | Industrial | Industrial | |
| Total Industrial | Total Clarke | Total Tanks | ICI200 |
| | Industrial | | |
| Total Industrial | Total Clarke | Total Tanks | ICI210SA |
| | Industrial | | |
| Total Industrial | Total Clarke | Total Tanks | ICI220VIC |
| | Industrial | | |
| Total Industrial | Total Clarke | Total Tanks | ICI230QLD |
| | Industrial | | |
| Total Industrial | Total Clarke | Total Tanks | ICI240NSW |
| | Industrial | | |
| Total Industrial | Total Clarke | Total Tanks | ICI250WA |
| | Industrial | | |

### Heuristics for Attribute Inclusion

Once a table has been selected to form a new dimension in the cube, the rows and columns of that table are automatically analysed to intelligently select which attributes should be included with the dimension.

### Heuristics

This decision is based on a number of heuristics and user configurable threshold values.

### Coverage

Coverage is defined as the percentage of rows with non-null values for a given attribute.

### Discrimination

Discrimination is defined as the cardinality of the set of attribute values divided by the number of non-null entries for that attribute in the table.

Process

for each column in the table

if Coverage < threshold_{coverage}

Ignore column (field is greyed out on the UI)

else

if field is numeric or
a string and field.length > threshold_{member} _{property} or
Discrimination > threshold_{discrimination}

Include column as member property

else

Include column as an attribute hierarchy

end if

end if

end for
Note that any of these classifications can be overridden by the user if desired.

### EXAMPLES

The following examples illustrate how this algorithm would apply in different scenarios.

### Example 1

Consider a table with 61 rows containing a “Delivery Method Code” column.

| Delivery Method Code | Row Count |
|---|---|
| | 61 |
| 3AUPOST | 1 |
| DHL | 4 |
| FEDEX | 2 |

Computing summary statistics for this table results in the following:

| Variable | Calculation | Result |
|---|---|---|
| Distinct value count | | 3 |
| Empty Data | | 61 |
| Total row count | | 68 |
| Coverage | =7/68 *100 | 10.29% |
| Discrimination | =3/7 *100 | 42.86% |

This column is too sparsely populated as indicated by the coverage metric. This column would be ignored.

### Example 2

Consider a table with 27 rows containing a “Discount Code” column.

| Discount Code | Row Count |
|---|---|
| | 27 |
| LARGE ACC | 20 |
| RETAIL | 21 |

Computing summary statistics for this table results in the following:

| Variable | Calculation | Result |
|---|---|---|
| Distinct value count | | 2 |
| Empty Data | | 27 |
| Total row count | | 68 |
| Coverage | =41/68 *100 | 60.29% |
| Discrimination | =2/41*100 | 4.88% |

This column has sufficient coverage and a low discrimination factor so it would be included as an attribute hierarchy.

### Example 3

Consider a table with 68 rows containing an address column with 68 distinct address values. The summary statistics for this table are as follows:

| Variable | Calculation | Result |
|---|---|---|
| Distinct value count | | 68 |
| Empty Data | | 0 |
| Total row count | | 68 |
| Coverage | =68/68 *100 | 100% |
| Discrimination | =68/68*100 | 100% |

This example would be created as member property as even though the data is 100% populated, it is also 100% unique

### Security Adapter

The applicants copending application 2008905207 described a method for replicating any security model inside an OLAP system. This method ultimately created one role per user to guarantee complete fidelity. However for large numbers of users, this method had performance implications.

The current invention alleviates these potential performance issues by creating a new synthetic dimension in the cube which relates an access schedule to all other dimensions in the cube. In preferred embodiment using Microsoft CRM, an owner dimension is introduced which associates each user with each entity as per the CRM security model. In this way, a particular user is guaranteed to only ever see records they have permission to, by filtering out any entities they are not related to.

One role is created in the cube for each role in CRM, and users are members of those roles as defined in CRM.

This method has an additional benefit in that it enriches the existing data by combining it with new security information that previously only existed in a metadata layer. For example, this new information can now be leveraged in reports and dashboards by slicing and filtering data by user.

### CRM Example

To make matters concrete consider this example where the following calculated members/sets have been created in the cube:

[Owner].[Login].[Me]
//The current user
CREATE MEMBER CURRENTCUBE.[Owner].[Login].[Me]
AS StrToMember(‘[Owner].[Login].[‘ + UserName( ) + ’]’);
[My Business Unit]
//The current user's business unit
CREATE SET CURRENTCUBE.[My Business Unit]
AS
NONEMPTY ([Business Unit].[Business Unit].MEMBERS,

([Owner].[Login].[Me], [Measures].[User Count])) −
[Business Unit].[Business

Unit].[All];
[My Business Unit and Descendants]
//The current user's business unit and all of its descendants
CREATE SET CURRENTCUBE.[My Business Unit and Descendants]
AS
HIERARCHIZE(DISTINCT( DESCENDANTS(

LinkMember([My Business Unit].Item(0),
[Business Unit].[Parent Business Unit])
)));

These members are used in the attribute security MDX to filter data dynamically according to the current logged on user. This has the following advantages

Changes to organization structure, or business unit membership only requires a re-process of the cube to take effect
Drastically reduced the amount of security information in the cube
Improves maintainability if manual changes need to be made
These calculated members can also be used in content to automatically filter reports to the currently logged on user

The attribute security is defined as following

### Business Unit Permissions (Invoice Example)

NONEMPTY([Invoice].[Invoice].MEMBERS, ([My Business Unit], [Measures].[Invoice Count]))+[Invoice]].[Invoice].UNKNOWNMEMBER−[Invoice].[Invoice].[All]

### Business Unit and Descendant Permissions (Invoice Example)

NONEMPTY([Invoice].[Invoice].MEMBERS, ([My Business Unit and Descendants], [Measures].[Invoice Count]))+[Invoice].[Invoice].UNKNOWNMEMBER−[Invoice].[Invoice].[All]

### Owner Permissions

NONEMPTY(([Invoice].[Invoice].MEMBERS, ([Invoice].[Login].[Me], [Measures].[Invoice Count]))+[Invoice].[Invoice].UNKNOWNMEMBER−[Invoice].[Invoice].[All]

### None Permissions

{{[Invoice].[Invoice].[Unknown]}}

### Navision Example

A Role will be created in the cube for each Role within NAV named according to the RoleID column of the permissions table.

Role permissions are assigned to dimensions as either read, or no access.

Dimension read permissions will by default be allow, and are removed when there are no permissions that

1. Are able to be matched to the ObjectID field in the Permissions table
2. Have permissions with RD=1. Dimensions are matched to ObjectID based on the Objects table in NAV.

Membership to these roles will be created according to the Windows ACL table. The Permissions table also contains table filters; these will not be included as the filters cannot be accessed through SQL.

TABLE 1
Windows ACL

| TimeStamp | Windows SID | ROLE ID |
|---|---|---|
| <Binary data> | S-1-5-21-1606980848-2146935855- | SUPER |
| | 839522115-2095 | |
| <Binary data> | S-1-5-21-1606980848-2146935855- | AWS_ADMIN |
| | 839522115-2100 | |
| <Binary data> | S-1-5-21-1606980848-2146935855- | AWS_ALL |
| | 839522115-2100 | |
| <Binary data> | S-1-5-21-1606980848-2146935855- | AWS_BANK |
| | 839522115-2100 | |
| <Binary data> | S-1-5-21-1606980848-2146935855- | AWS_PRODUC |
| | 839522115-2100 | |
| <Binary data> | S-1-5-21-1606980848-2146935855- | AWS_SALES |
| | 839522115-2100 | |
| <Binary data> | S-1-5-21-1606980848-2146935855- | AWS_SM |
| | 839522115-2100 | |

TABLE 2
Permissions

| TimeStamp | ROLEID | Object Type | Object ID | Rd | Ins | Mod | Del | Ex | Table Filter |
|---|---|---|---|---|---|---|---|---|---|
| <Binary data> | ADCS ALL | 0 | 7700 | 1 | 0 | 0 | 0 | 0 | <Binary data> |
| <Binary data> | ADCS ALL | 0 | 7701 | 1 | 0 | 0 | 0 | 0 | <Binary data> |
| <Binary data> | ADCS ALL | 0 | 7702 | 1 | 0 | 0 | 0 | 0 | <Binary data> |
| <Binary data> | ADCS ALL | 0 | 7703 | 1 | 0 | 0 | 0 | 0 | <Binary data> |
| <Binary data> | ADCS ALL | 0 | 7704 | 1 | 0 | 0 | 0 | 0 | <Binary data> |
| <Binary data> | ADCS | 0 | 7700 | 1 | 1 | 1 | 1 | 0 | <Binary data> |
| | SETUP | | | | | | | | |
| <Binary data> | ADCS | 0 | 7701 | 1 | 1 | 1 | 1 | 0 | <Binary data> |
| | SETUP | | | | | | | | |
| <Binary data> | ADCS | 0 | 7702 | 1 | 1 | 1 | 1 | 0 | <Binary data> |
| | SETUP | | | | | | | | |
| <Binary data> | ADCS | 0 | 7703 | 1 | 1 | 1 | 1 | 0 | <Binary data> |
| | SETUP | | | | | | | | |

### Next Steps

The next step after the structuring of the data store is to construct a schedule of operations to extract the data, transform it and load it into the staging database. This process is called ETL. This schedule can then be translated into an appropriate language for the database management system, such as SQL Server Integration Services, and then handed off for execution. A preferred ETL builder is described in a co-pending application 2009900510 filed simultaneously with this application.

The methodologies herein can be extended to collect and aggregate data from multiple instances of a source application's relational database to a single consolidated OLAP cube. For example: a multi-national company running Microsoft Dynamics NAV at each branch office; the invention can be extended to connect to the relational database behind each instance of the application and bring each office's data into the staging database to create a consolidated view of company operations. This is facilitated by the techniques previously described, such as Schema Merging.

When large volumes of data of a transactional nature are included in the cube, past a particular threshold, the Wizard creates what is known as a relational dimension or ROLAP dimension, rather than a standard OLAP dimension. This results in smaller cubes, less processing time and greater query performance.

From the above it can be seen that the present invention provides a time and cost saving solution by automatically designing an appropriate OLAP cube for business analysis of data contained in a source system.

Furthermore, one skilled in the art would recognise that these techniques are generally applicable to ERP business applications and could be readily applied to other systems such Microsoft Dynamics AX and Microsoft Dynamics GP.

The invention's handling of security demonstrates a method that provides a time and cost saving by transparently replicating disparate security models in an OLAP cube in a completely automated manner.

Those skilled in the art will realise that this invention may be implemented in embodiments other than those described without departing from the core teachings of this invention.

1. A computer operable method for structuring a data store by analysing the source data bases using a computer to carry out the steps of relationship discovery, schema merging, hierarchy discovery, heuristics for attribute inclusion.

2. A method as claimed in claim 1 which also includes the step of denormalising data.

3. A method as claimed in claim 1 in which relationships are discovered using a computer to statistically analyse the source data and by using guided relationship discovery with the user.

4. A method as claimed in claim 1 in which hierarchies are discovered using different adapters to naturally discover these hierarchies in different domains.

5. A method as claimed in claim 1 in which table columns in the source database are analysed using heuristics to select which ones should be included with the dimension.

6. A method as claimed in claim 2 wherein a comprehensive picture of relationships in the data is built from multiple sources including foreign keys in the source database, existing cube structure, relationships discovered from statistical analysis of the source data and relationships suggested by the user.

7. A method as claimed in claim 2 where the search for statistical relationships between different tables in the source database is made possible by using heuristics such as ignoring columns with incompatible data types to reduce the search space.

8. A method as claimed in claim 2 in which the source data basses are an ERP or CRM database.

9. A method as claimed in anyone of the preceding claims in which a computer is used to collect and aggregate data from multiple instances of a source application's relational database to a single consolidated OLAP cube.

10. A computer operable method to carry security settings from a source data base to an OLAP cube which includes the steps of using a computer to create a new synthetic dimension in the OLAP cube which is a common trait related to all other dimensions in the cube and one role is created for each role in the source data base and users are treated as members of those roles as defined in the source data base.

11. A method as claimed in claim 7 in which the synthetic dimension is an owner dimension from CRM and ERP related to the business unit for which the database stores information.

12. A computer readable medium encoded with a data structure to analyse the source data bases using a computer to carry out the steps of relationship discovery, schema merging, hierarchy discovery, heuristics for attribute inclusion.

13. A computer readable medium as claimed in claim 11 which also includes the step of denormalising data.

14. A computer readable medium encoded with a data structure to carry security settings from a source data base to an OLAP cube which includes the steps of creating a new synthetic dimension in the OLAP cube which is a common trait related to all other dimensions in the cube and one role is created for each role in the source data base and users are treated as members of those roles as defined in the source data base.
